(19) United States
(12) Patent Application Publication
(10) Pub. No.: US 2025/0010428 A1
(43) Pub. Date: Jan. 9, 2025

(54) POLISHING APPARATUS AND POLISHING METHOD

(71) Applicant: EBARA CORPORATION, Tokyo (JP)

(72) Inventor: SAURABH KULKARNI, Tokyo (JP)

(73) Assignee: EBARA CORPORATION, Tokyo (JP)

(21) Appl. No.: 18/732,570

(22) Filed: Jun. 3, 2024

(30) Foreign Application Priority Data
Jul. 4, 2023 (JP) 2023-109778

(51) Int. Cl. B24B 49/12; B08B 3/02; B08B 7/02; B24D 7/12

(52) U.S. Cl. CPC B24B 49/12; B08B 3/02; B08B 7/028; B24D 7/12

(57) ABSTRACT

The disclosure provides a polishing apparatus capable of removing a polishing liquid or polishing debris from a light passing portion of a polishing pad. A polishing apparatus 1 includes a polishing table 3 supporting a polishing pad 2 that has a light passing portion 33; a polishing head 5 pressing a substrate W against a polishing surface 2a of the polishing pad 2; an optical sensor 21 disposed in the polishing table 3, irradiating light to the substrate W through the light passing portion 33, and receiving reflected light from the substrate W through the light passing portion 33; and a cleaning portion 12 forming a cleaning space CS that covers the light passing portion 33 above the light passing portion 33 and supplying a cleaning fluid to the light passing portion 33 through the cleaning space CS.

### CROSS-REFERENCE TO RELATED APPLICATION

This application claims the priority benefits of Japanese application no. 2023-109778, filed on Jul. 4, 2023. The entirety of the above-mentioned patent application is hereby incorporated by reference herein and made a part of this specification.

### BACKGROUND

### Technical Field

The disclosure relates to a polishing apparatus and a polishing method for polishing a substrate such as a wafer.

### Description of Related Art

In the manufacturing process of a semiconductor device, a chemical mechanical polishing (CMP) apparatus is used for polishing the surface of a substrate such as a wafer. The CMP apparatus includes a polishing pad attached to a polishing table, and a polishing head for pressing the substrate against the polishing surface of the polishing pad. The CMP apparatus supplies a polishing liquid (for example, slurry) onto the polishing pad, while pressing the substrate against the polishing surface of the polishing pad with the polishing head and bringing the surface of the substrate into sliding contact with the polishing surface of the polishing pad. The surface of the substrate is planarized by the chemical action of the polishing liquid and the mechanical action of the abrasive grains contained in the polishing liquid and/or the polishing pad.

The polishing of the substrate is completed when the film (insulating film, silicon layer, etc.) constituting the surface of the substrate is polished to a film thickness that reaches a target film thickness. The polishing apparatus includes an optical film thickness measuring device to measure the film thickness of the substrate. The optical film thickness measuring device is configured to irradiate light to the substrate and receive the light reflected from the substrate with an optical sensor disposed inside the polishing table, and determine the film thickness of the substrate based on the intensity of the reflected light measured by a spectroscope. The polishing pad has a through hole or a transparent window as a light passing portion for the light irradiated from the optical sensor to the substrate and the light reflected from the substrate to pass.

### RELATED ART

### Patent Document

[Patent Document 1] Japanese Patent Application Laid-Open No. 2020-104191

However, as the substrate is polished, the polishing liquid or polishing debris may adhere to the light passing portion (through hole or transparent window) of the polishing pad, reducing the intensity of the reflected light from the substrate that passes through the light passing portion.

The disclosure provides a polishing apparatus and a polishing method capable of removing the polishing liquid or polishing debris from the light passing portion of the polishing pad.

### SUMMARY

In one aspect, a polishing apparatus is provided, including: a polishing table supporting a polishing pad that has a light passing portion; a polishing head pressing a substrate against a polishing surface of the polishing pad; an optical sensor disposed in the polishing table, irradiating light to the substrate through the light passing portion, and receiving reflected light from the substrate through the light passing portion; and a cleaning portion forming a cleaning space that covers the light passing portion above the light passing portion and supplying a cleaning fluid to the light passing portion through the cleaning space.

In one aspect, the polishing apparatus further includes: a fluid discharge line discharging the cleaning fluid from the cleaning space; and an operation controller controlling an operation of the cleaning portion, in which the cleaning portion includes: a cleaning cover forming the cleaning space inside; a cleaning nozzle supplying the cleaning fluid into the cleaning space; and an actuator moving the cleaning cover up and down, in which the operation controller is configured to give a command to the actuator to lower the cleaning cover into contact with the polishing surface of the polishing pad, surround the light passing portion with the cleaning cover, and close the cleaning space.

In one aspect, the cleaning nozzle includes at least one of a liquid nozzle that supplies a liquid as the cleaning fluid, a jet nozzle that supplies a jet of fluid as the cleaning fluid, and a chemical liquid nozzle that supplies a chemical liquid as the cleaning fluid.

In one aspect, the cleaning portion includes an ultrasonic vibrator that generates ultrasonic waves and is configured to propagate the ultrasonic waves via the cleaning fluid.

In one aspect, the cleaning portion further includes a cleaning cover that forms the cleaning space inside, and the ultrasonic vibrator is disposed in the cleaning cover.

In one aspect, the cleaning portion further includes a cleaning nozzle that supplies the cleaning fluid into the cleaning space, and the ultrasonic vibrator is disposed in the cleaning nozzle.

In one aspect, the light passing portion is a through hole formed in the polishing pad.

In one aspect, the polishing apparatus further includes a fluid discharge line discharging the cleaning fluid from the cleaning space, in which the fluid discharge line communicates with the through hole and is configured to discharge the cleaning fluid from the cleaning space through the through hole.

In one aspect, the light passing portion is a transparent window made of a material that allows light to pass through.

In one aspect, the polishing apparatus further includes a fluid discharge line discharging the cleaning fluid from the cleaning space, in which the cleaning portion includes a cleaning cover that forms the cleaning space inside, and the fluid discharge line communicates with an opening formed on an inner surface of the cleaning cover and is configured to discharge the cleaning fluid from the cleaning space through the opening.

In one aspect, the cleaning portion further includes a load measuring device that measures a load applied to the cleaning cover, and the operation controller is configured to give a command to the actuator to lower the cleaning cover until the load measured by the load measuring device reaches a load target value.

In one aspect, the polishing apparatus further includes: a table motor rotating the polishing table; and a cleaning portion horizontal moving mechanism horizontally moving the cleaning portion, in which the operation controller is configured to control operations of the table motor and the cleaning portion horizontal moving mechanism, and is configured to give commands to the table motor and the cleaning portion horizontal moving mechanism to rotate the polishing table and horizontally move the cleaning portion so that a position of the light passing portion coincides with a position of the cleaning cover.

In one aspect, the polishing apparatus further includes an operation controller that controls an operation of the cleaning portion, in which the cleaning portion includes a mirror that is disposed on an optical path of the light irradiated from the optical sensor through the light passing portion, the optical sensor is configured to receive reflected light from the mirror through the light passing portion, and the operation controller is configured to detect a cleaning endpoint of the light passing portion, which is a time point when an intensity of the reflected light from the mirror exceeds a threshold value.

In one aspect, the polishing apparatus further includes an operation controller that controls an operation of the cleaning portion, in which the cleaning portion includes an imaging device that generates an image of the light passing portion, and the operation controller is configured to detect a cleaning endpoint of the light passing portion based on the image.

In one aspect, the polishing apparatus further includes an operation controller that controls an operation of the cleaning portion, in which the operation controller is configured to determine whether or not it is a cleaning time for the light passing portion based on the reflected light from the substrate.

In one aspect, a polishing method is provided, including: pressing a substrate against a polishing surface of a polishing pad supported by a polishing table, and polishing the substrate; irradiating light to the substrate through a light passing portion provided in the polishing pad, and receiving reflected light from the substrate through the light passing portion with an optical sensor disposed in the polishing table during polishing of the substrate; forming a cleaning space that covers the light passing portion above the light passing portion with a cleaning portion before or after polishing of the substrate; and supplying a cleaning fluid to the light passing portion through the cleaning space with the cleaning portion.

In one aspect, forming the cleaning space that covers the light passing portion above the light passing portion with the cleaning portion includes disposing the cleaning portion above the light passing portion, and lowering a cleaning cover of the cleaning portion into contact with the polishing surface of the polishing pad to close the cleaning space formed inside the cleaning cover and surround the light passing portion with the cleaning cover; supplying the cleaning fluid to the light passing portion through the cleaning space with the cleaning portion includes supplying the cleaning fluid to the light passing portion from a cleaning nozzle of the cleaning portion through the cleaning space; and the polishing method further includes discharging the cleaning fluid from the cleaning space through a fluid discharge line.

In one aspect, the polishing method further includes generating ultrasonic waves with an ultrasonic vibrator and propagating the ultrasonic waves via the cleaning fluid.

In one aspect, forming the cleaning space that covers the light passing portion above the light passing portion with the cleaning portion includes measuring a load applied to a cleaning cover of the cleaning portion with a load measuring device, and lowering the cleaning cover until the measured load reaches a load target value to form the cleaning space that covers the light passing portion above the light passing portion.

In one aspect, disposing the cleaning portion above the light passing portion includes rotating the polishing table and horizontally moving the cleaning portion so that a position of the light passing portion coincides with a position of the cleaning cover, to dispose the cleaning portion above the light passing portion.

In one aspect, the polishing method further includes irradiating light to a mirror through the light passing portion, and receiving reflected light from the mirror with the optical sensor; and detecting a cleaning endpoint of the light passing portion, which is a time point when an intensity of the reflected light exceeds a threshold value.

In one aspect, the polishing method further includes: generating an image of a light projecting and receiving surface with an imaging device; and detecting a cleaning endpoint of the light passing portion based on the image.

In one aspect, the polishing method further includes determining whether or not it is a cleaning time for the light passing portion based on the reflected light from the substrate.

According to the disclosure, the cleaning portion supplies the cleaning fluid to the light passing portion through the closed cleaning space facing the light passing portion of the polishing pad, thereby removing the polishing liquid or polishing debris from the light passing portion.

### BRIEF DESCRIPTION OF THE DRAWINGS

FIG. 1 is a perspective view showing one embodiment of the polishing apparatus.

FIG. 2 is a cross-sectional view of the polishing apparatus shown in FIG. 1.

FIG. 3 is a diagram showing an example of the spectrum generated by the data processor.

FIG. 4 is a plan view showing an example of the positional relationship between the substrate and the polishing table.

FIG. 5 is a schematic view showing one embodiment of the cleaning portion.

FIG. 6A and FIG. 6B are plan views showing an example of the positional relationship between the cleaning portion and the polishing table.

FIG. 7 is a schematic view showing a state where the actuator lowers the cleaning cover.

FIG. 8 is a schematic view showing how the liquid nozzle supplies the liquid into the cleaning space.

FIG. 9 is a schematic view showing how the jet nozzle supplies a jet of fluid into the cleaning space.

FIG. 10 is a schematic view showing how the chemical liquid nozzle supplies the chemical liquid into the cleaning space.

FIG. 11 is a schematic view showing one embodiment in which the ultrasonic vibrator propagates ultrasonic waves to the light passing portion via the cleaning fluid.

FIG. 12 is a schematic view showing another embodiment of the cleaning portion.

FIG. 13 is a schematic view showing one embodiment in which the cleaning endpoint of the light passing portion is detected using the mirror of the cleaning portion.

FIG. 14 is a schematic view showing yet another embodiment of the cleaning portion.

FIG. 15 is a flowchart showing one embodiment of the polishing method of a substrate.

FIG. 16 is a flowchart showing one embodiment of the polishing method of a substrate.

FIG. 17 is a cross-sectional view showing another embodiment of the polishing apparatus.

FIG. 18 is a schematic view showing one embodiment of the cleaning portion of the polishing apparatus shown in FIG. 17.

### DESCRIPTION OF THE EMBODIMENTS

Hereinafter, embodiments of the disclosure will be described with reference to the drawings.

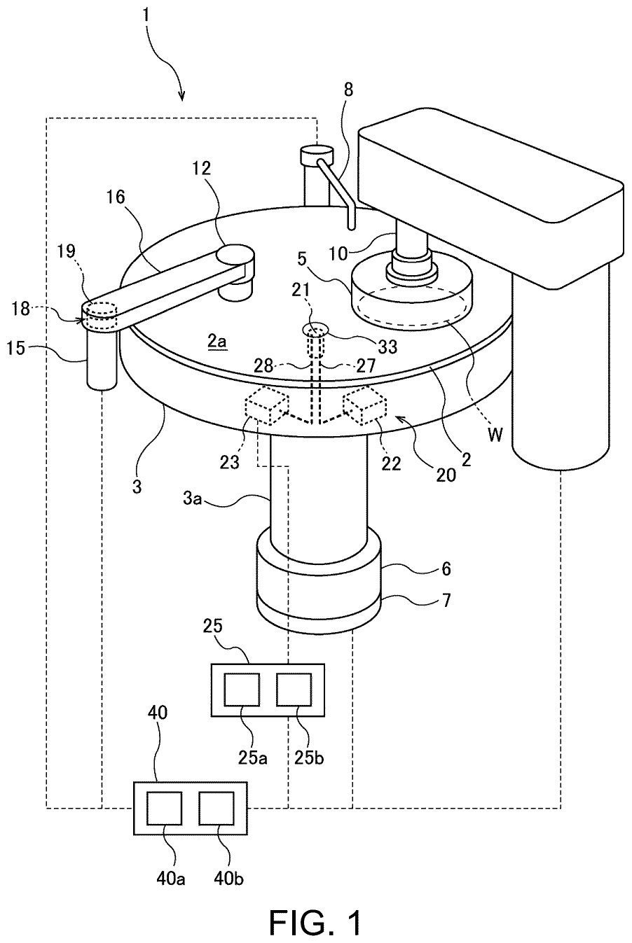

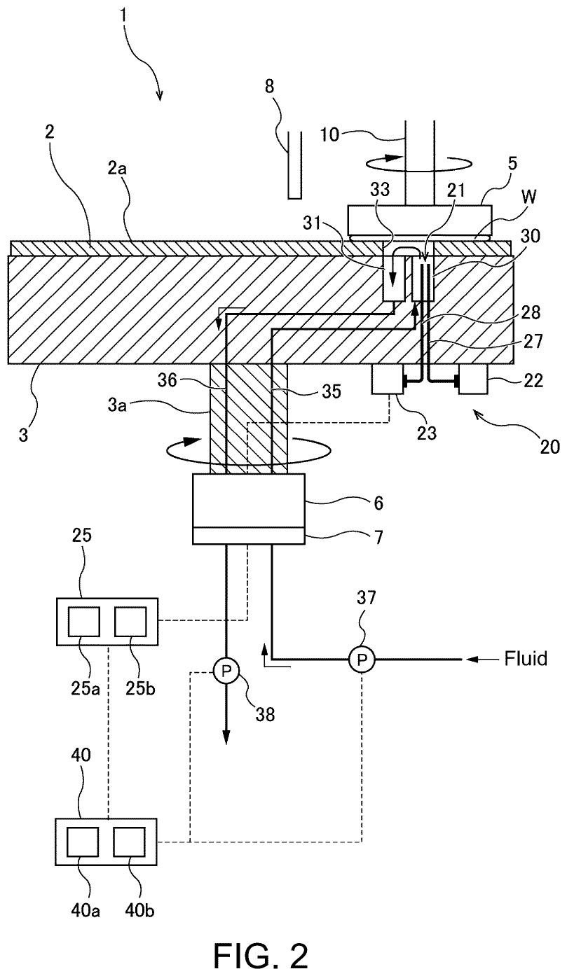

FIG. 1 is a schematic view showing one embodiment of a polishing apparatus 1, and FIG. 2 is a cross-sectional view showing one embodiment of the polishing apparatus 1 shown in FIG. 1. The polishing apparatus 1 is an apparatus for chemically and mechanically polishing a substrate W such as a wafer or a panel. As shown in FIG. 1, the polishing apparatus 1 includes a polishing table 3 that supports a polishing pad 2, a polishing head 5 that presses the substrate W against a polishing surface 2a of the polishing pad 2, a table motor 6 that rotates the polishing table 3, and a polishing liquid supply nozzle 8 for supplying a polishing liquid (for example, slurry) to the polishing pad 2. The polishing pad 2 is attached to the upper surface of the polishing table 3. The exposed surface of the polishing pad 2 constitutes the polishing surface 2a for polishing the substrate W.

The table motor 6 is disposed below the polishing table 3, and the polishing table 3 is connected to the table motor 6 via a table shaft 3a. The table motor 6 is configured to rotate the polishing table 3 and the polishing pad 2 around the table shaft 3a in the direction indicated by the arrow in FIG. 2. An example of the table motor 6 is a servo motor. An angle detector 7 for detecting the rotation angle of the polishing table 3 is attached to the table motor 6. An example of the angle detector 7 is a rotary encoder.

The polishing head 5 is connected to a polishing head shaft 10, and the polishing head shaft 10 is connected to a polishing head rotating mechanism (not shown). The polishing head rotating mechanism includes, for example, a combination of a motor, a timing pulley, and a belt. The polishing head rotating mechanism rotates the polishing head 5 together with the polishing head shaft 10 in the direction indicated by the arrow in FIG. 2. The polishing head 5 is configured to be capable of holding the substrate W on the lower surface thereof by vacuum suction. The substrate W is held by the polishing head 5 with the surface to be polished facing downward.

The polishing apparatus 1 further includes an operation controller 40. The polishing head 5, the table motor 6, the angle detector 7, the polishing liquid supply nozzle 8, and the polishing head rotating mechanism are electrically connected to the operation controller 40, and the operations of the polishing head 5, the table motor 6, the polishing liquid supply nozzle 8, and the polishing head rotating mechanism are controlled by the operation controller 40. The angle detector 7 detects the rotation angle of the polishing table 3 and outputs a signal indicating the detected rotation angle. The signal output from the angle detector 7 is sent to the operation controller 40.

The operation controller 40 includes a storage device 40a in which a program is stored, and a calculation device 40b that executes calculation according to an instruction included in the program. The operation controller 40 includes at least one computer. The storage device 40a includes a main storage device such as a random access memory (RAM), and an auxiliary storage device such as a hard disk drive (HDD) and a solid state drive (SSD). Examples of the calculation device 40b include a CPU (Central Processing Unit) and a GPU (Graphics Processing Unit). However, the specific configuration of the operation controller 40 is not limited to these examples.

The substrate W is polished as follows. The polishing head 5 and the polishing table 3 are respectively rotated in the directions indicated by the arrows in FIG. 2, and the polishing liquid is supplied from the polishing liquid supply nozzle 8 onto the polishing surface 2a of the polishing pad 2. In this state, the polishing head 5 presses the substrate W against the polishing surface 2a of the polishing pad 2.

More specifically, the operation controller 40 gives commands to the polishing head 5, the table motor 6, the polishing liquid supply nozzle 8, and the polishing head rotating mechanism, and supplies the polishing liquid (slurry) onto the polishing pad 2 from the polishing liquid supply nozzle 8 while rotating the polishing head 5 and the polishing table 3. In this state, the substrate W is pressed against the polishing surface 2a of the polishing pad 2 by the polishing head 5, thereby polishing the substrate W. The surface of the substrate W is polished by a combination of the chemical action of the polishing liquid and the mechanical action of the abrasive grains contained in the polishing liquid and/or the polishing pad 2.

The polishing apparatus 1 includes an optical film thickness measuring device 20 that measures the film thickness of the substrate W. The optical film thickness measuring device 20 includes an optical sensor 21, a light source 22, a spectroscope 23, and a data processor 25. The optical sensor 21 is disposed inside the polishing table 3, and the light source 22 and the spectroscope 23 are attached to the polishing table 3. The optical sensor 21, the light source 22, and the spectroscope 23 rotate together with the polishing table 3 and the polishing pad 2. The optical sensor 21 is positioned so as to cross the surface of the substrate W on the polishing pad 2 every time the polishing table 3 and the polishing pad 2 make one rotation. The optical sensor 21 is connected to the light source 22 and the spectroscope 23, and the spectroscope 23 is connected to the data processor 25.

The optical film thickness measuring device 20 includes a light-projecting optical fiber cable 27 that guides the light emitted from the light source 22 to the surface of the substrate W, and a light-receiving optical fiber cable 28 that receives the reflected light from the substrate W and sends the reflected light to the spectroscope 23. The tip of the light-projecting optical fiber cable 27 and the tip of the light-receiving optical fiber cable 28 are located inside the polishing table 3. The tip of the light-projecting optical fiber cable 27 and the tip of the light-receiving optical fiber cable 28 constitute the optical sensor 21 that guides light to the surface of the substrate W and receives the reflected light from the substrate W. The other end of the light-projecting optical fiber cable 27 is connected to the light source 22, and the other end of the light-receiving optical fiber cable 28 is connected to the spectroscope 23. The spectroscope 23 is configured to resolve the reflected light from the substrate W according to wavelength and measure the intensity of the reflected light over a predetermined wavelength range.

As shown in FIG. 2, the polishing table 3 has a first hole 30 and a second hole 31 opening on the upper surface thereof. The polishing pad 2 has a light passing portion at a position corresponding to the first hole 30 and the second hole 31. In this embodiment, the light passing portion is a through hole 33 formed in the polishing pad 2. The first hole 30 and the second hole 31 communicate with the through hole 33, and the through hole 33 opens on the polishing surface 2a. The optical sensor 21, which is constituted by the tip of the light-projecting optical fiber cable 27 and the tip of the light-receiving optical fiber cable 28, is disposed in the first hole 30 and is located below the through hole 33.

The light emitted by the light source 22 is guided from the optical sensor 21 through the light-projecting optical fiber cable 27 to the substrate W via the through hole 33. The reflected light from the substrate W is received by the optical sensor 21 through the through hole 33, and is sent to the spectroscope 23 through the light-receiving optical fiber cable 28. The spectroscope 23 resolves the reflected light according to the wavelength thereof and measures the intensity of the reflected light at each wavelength to generate reflected light intensity measurement data. The reflected light intensity measurement data is sent from the spectroscope 23 to the data processor 25.

The data processor 25 is configured to generate a spectrum of the reflected light from the substrate W from the reflected light intensity measurement data. The spectrum of the reflected light is expressed as a line graph (that is, a spectral waveform) that shows the relationship between the wavelength and intensity of the reflected light. The intensity of the reflected light can also be expressed as a relative value such as reflectance or relative reflectance.

The data processor 25 is configured to determine the film thickness of the substrate W from the spectrum of the reflected light. A known method is used to determine the film thickness of the substrate W based on the spectrum. For example, the data processor 25 determines a reference spectrum having a shape closest to the spectrum of the reflected light from within a reference spectrum library, and determines the film thickness associated with this determined reference spectrum. In another example, the data processor 25 performs a Fourier transform on the spectrum of the reflected light and determines the film thickness from the obtained frequency spectrum.

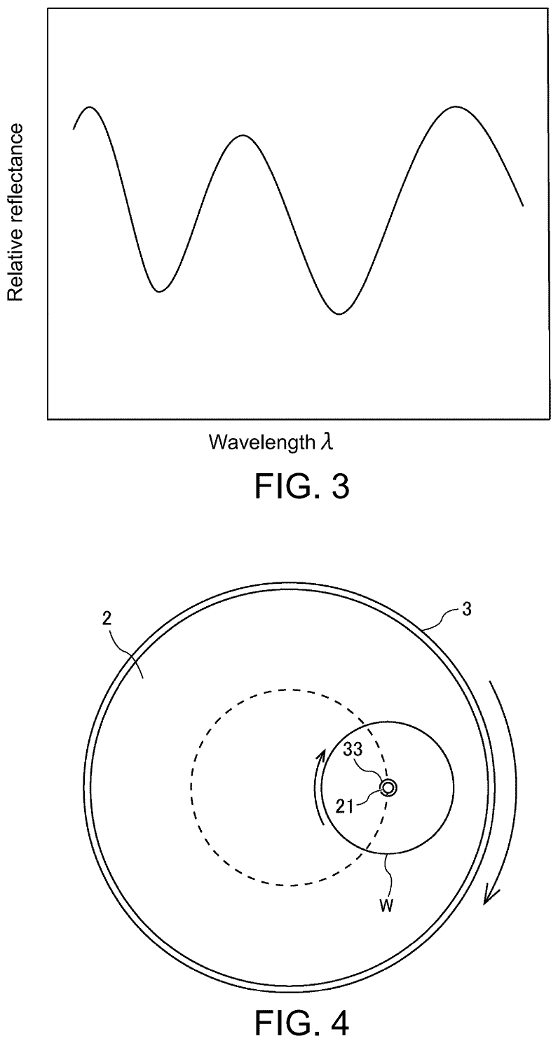

FIG. 3 is a diagram showing an example of the spectrum generated by the data processor 25. The spectrum is expressed as a line graph (that is, a spectral waveform) that shows the relationship between the wavelength and intensity of light. In FIG. 3, the horizontal axis represents the wavelength of the reflected light from the substrate W, and the vertical axis represents the relative reflectance derived from the intensity of the reflected light. The relative reflectance is an index value that indicates the intensity of the reflected light, and is the ratio of the intensity of light to a predetermined reference intensity. By dividing the intensity of light (measured intensity) at each wavelength by the predetermined reference intensity, unnecessary noise such as variations in intensity inherent to the optical system of the apparatus or the light source can be removed from the measured intensity.

In the example shown in FIG. 3, the spectrum of the reflected light is a spectral waveform that shows the relationship between the relative reflectance and the wavelength of the reflected light, but the spectrum of the reflected light may also be a spectral waveform that shows the relationship between the intensity of the reflected light itself and the wavelength of the reflected light.

FIG. 4 is a plan view showing an example of the positional relationship between the substrate W and the polishing table 3. The optical sensor 21 is disposed to face the substrate W held by the polishing head 5. As shown in FIG. 4, during polishing of the substrate W, the optical sensor 21 moves so as to cross the substrate W by the rotation of the polishing table 3. Every time the polishing table 3 rotates, light is irradiated from the optical sensor 21 to a measurement point on the substrate W. In this embodiment, the optical film thickness measuring device 20 includes one optical sensor 21, but in one embodiment, the optical film thickness measuring device 20 may include a plurality of optical sensors 21. For example, the optical film thickness measuring device 20 may include two optical sensors 21 located at different distances from the center of the polishing table 3, and the two optical sensors 21 may irradiate different regions of the substrate W with light to measure the film thicknesses in the different regions of the substrate W.

As shown in FIG. 2, the polishing apparatus 1 includes a fluid supply line 35 for supplying a fluid to the through hole 33 through the first hole 30, a fluid discharge line 36 for discharging the fluid from the through hole 33 through the second hole 31, a supply pump 37 connected to the fluid supply line 35, and a discharge pump 38 connected to the fluid discharge line 36. The fluid supply line 35 is connected to the first hole 30 and communicates with the through hole 33. The fluid discharge line 36 is connected to the second hole 31 and communicates with the through hole 33.

A fluid (for example, pure water) supplied from a fluid supply source (not shown) flows to the fluid supply line 35. The supply pump 37 is configured to pressurize the fluid flowing through the fluid supply line 35. The fluid pressurized by the supply pump 37 is supplied from the fluid supply line 35 through the first hole 30 to the through hole 33. The discharge pump 38 is configured to draw the fluid flowing through the fluid discharge line 36. The fluid supplied to the through hole 33 flows into the second hole 31 and is discharged from the fluid discharge line 36. The supply pump 37 and the discharge pump 38 are electrically connected to the operation controller 40, and the operations of the supply pump 37 and the discharge pump 38 are controlled by the operation controller 40.

During polishing of the substrate W, the operation controller 40 gives a command to the supply pump 37 to supply the fluid to the first hole 30 and the through hole 33 through the fluid supply line 35. Thereby, the fluid fills the first hole 30 and the through hole 33, and flows from the through hole 33 into the second hole 31. The operation controller 40 gives a command to the discharge pump 38 to discharge the fluid through the fluid discharge line 36. The polishing liquid used to polish the substrate W is discharged together with the fluid, thereby ensuring the optical path for measuring the film thickness of the substrate W.

The data processor 25 of the optical film thickness measuring device 20 is electrically connected to the operation controller 40. The operation controller 40 controls the polishing operation for the substrate W based on the film thickness of the substrate W determined by the data processor 25. For example, the operation controller 40 is configured to detect a polishing endpoint of the substrate W, which is a time point when the film thickness of the substrate W reaches a target film thickness, and terminate polishing of the substrate W based on the detected polishing endpoint. In this case, the operation controller 40 gives commands to the table motor 6 and the polishing head rotating mechanism based on the polishing endpoint of the substrate W to stop the rotation of the polishing table 3 and the polishing head 5 and terminate polishing of the substrate W.

In one embodiment, the operation controller 40 is configured to detect a change point of a polishing condition of the substrate W, which is a time point when the thickness of the substrate W reaches a predetermined value, and change the polishing condition of the substrate W based on the detected change point of the polishing condition.

The data processor 25 includes a storage device 25a in which a program is stored, and a calculation device 25b that executes calculation according to an instruction included in the program. The data processor 25 includes at least one computer. The storage device 25a includes a main storage device such as a random access memory (RAM), and an auxiliary storage device such as a hard disk drive (HDD) and a solid state drive (SSD). Examples of the calculation device 25b include a CPU (Central Processing Unit) and a GPU (Graphics Processing Unit). However, the specific configuration of the data processor 25 is not limited to these examples. In one embodiment, the data processor 25 and the operation controller 40 may be integrated into one unit using at least one computer.

As shown in FIG. 1, the polishing apparatus 1 further includes a cleaning portion 12 that supplies a cleaning fluid to the through hole (light passing portion) 33 of the polishing pad 2, a cleaning arm 16 connected to the cleaning portion 12, a support shaft 15 connected to the cleaning arm 16, and a cleaning portion horizontal moving mechanism 18 that moves the cleaning portion 12 horizontally. The cleaning portion horizontal moving mechanism 18 is disposed inside the cleaning arm 16 and is connected to the support shaft 15. The cleaning portion horizontal moving mechanism 18 is configured to swing (that is, move horizontally) the cleaning arm 16 and the cleaning portion 12 around the axis of the support shaft 15.

When the cleaning arm 16 is moved horizontally by the cleaning portion horizontal moving mechanism 18, the cleaning portion 12 moves between a position above the polishing table 3 and a position radially outside the polishing table 3. The cleaning portion horizontal moving mechanism 18 includes, for example, a combination of a servo motor, a timing pulley, and a belt. The cleaning portion horizontal moving mechanism 18 includes an angle detector 19 that detects the rotation angle of the cleaning portion 12 around the support shaft 15. An example of the angle detector 19 is a rotary encoder. The cleaning portion horizontal moving mechanism 18 is electrically connected to the operation controller 40, and the operation of the cleaning portion horizontal moving mechanism 18 is controlled by the operation controller 40. The angle detector 19 detects the rotation angle of the cleaning portion 12 around the support shaft 15, and outputs a signal indicating the detected rotation angle. The signal output from the angle detector 19 is sent to the operation controller 40.

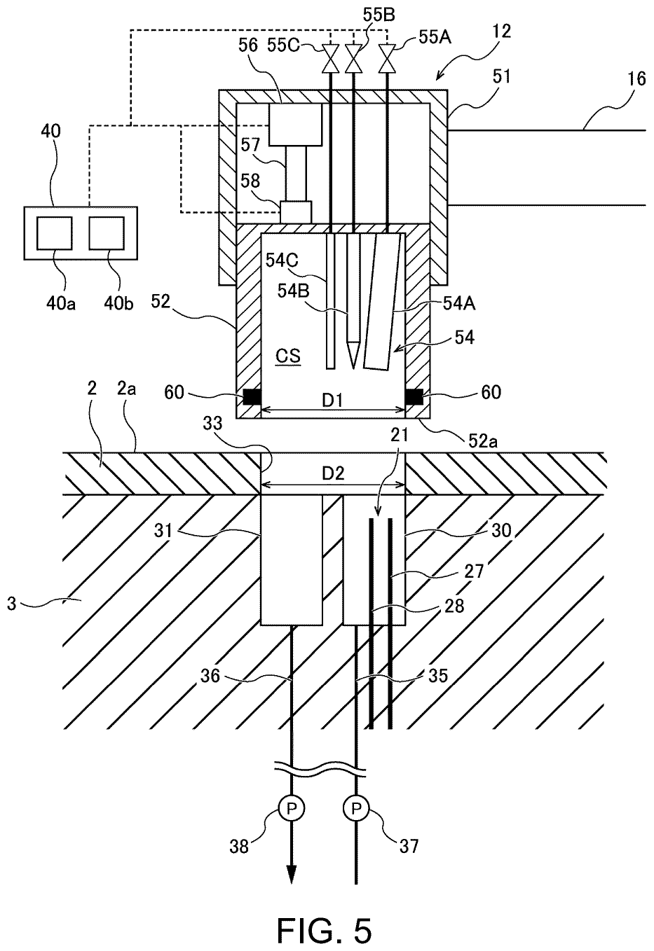

FIG. 5 is a schematic view showing one embodiment of the cleaning portion 12. The cleaning portion 12 is configured to form a cleaning space CS that covers the through hole (light passing portion) 33 above the through hole (light passing portion) 33, and supply the cleaning fluid to the through hole (light passing portion) 33 through the cleaning space CS. The cleaning portion 12 includes a housing 51 connected to the cleaning arm 16, a cleaning cover 52 that forms the cleaning space CS, a cleaning nozzle 54 that supplies the cleaning fluid into the cleaning space CS, an actuator 56 that moves the cleaning cover 52 up and down, and a load measuring device 58 that measures the load applied to the cleaning cover 52. A part of the cleaning cover 52, the actuator 56, and the load measuring device 58 are accommodated inside the housing 51. The housing 51 and the cleaning cover 52 have a cylindrical shape with a closed top, and the inner diameter of the housing 51 is larger than the outer diameter of the cleaning cover 52. The cleaning space CS is formed inside the cleaning cover 52. The cleaning cover 52 and the cleaning space CS open downward. The shape of the housing 51 and the cleaning cover 52 is not limited to this embodiment, and for example, the housing 51 and the cleaning cover 52 may have a polygonal horizontal cross-sectional shape such as oval or square.

When cleaning the through hole (light passing portion) 33, the cleaning portion 12 and the through hole (light passing portion) 33 are aligned with each other, and the cleaning portion 12 is positioned above (directly above) the through hole (light passing portion) 33 of the polishing pad 2. The inner diameter D1 of the cleaning cover 52 is equal to or larger than the inner diameter D2 of the through hole (light passing portion) 33. That is, the horizontal cross section of the cleaning space CS is equal to or larger than the horizontal cross section of the through hole (light passing portion) 33.

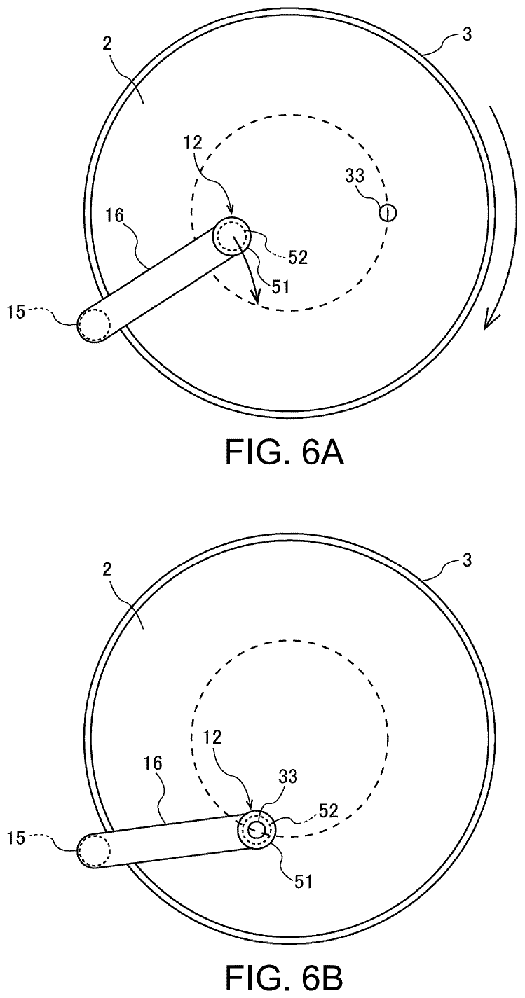

FIG. 6A and FIG. 6B are plan views showing an example of the positional relationship between the cleaning portion 12 and the polishing table 3. FIG. 6A shows a state where the cleaning portion 12 and the through hole (light passing portion) 33 are not aligned with each other, and FIG. 6B shows a state where the cleaning portion 12 and the through hole (light passing portion) 33 are aligned with each other.

The operation controller 40 is configured to rotate the polishing table 3 and horizontally move the cleaning portion 12 so that the position of the through hole (light passing portion) 33 coincides with the position of the cleaning cover 52 of the cleaning portion 12 when viewed from above the polishing table 3. More specifically, the operation controller 40 rotates the polishing table 3 and horizontally moves the cleaning portion 12 so that the position of the through hole (light passing portion) 33 coincides with the position of the cleaning cover 52 of the cleaning portion 12 based on a signal indicating the rotation angle of the polishing table 3 output from the angle detector 7 (see FIG. 1) and a signal indicating the rotation angle of the cleaning portion 12 output from the angle detector 19 (see FIG. 1). In this manner, as shown in the example of FIG. 6B, the operation controller 40 positions the cleaning portion 12 above (directly above) the through hole (light passing portion) 33 of the polishing pad 2.

As shown in FIG. 5, the cleaning nozzle 54 is fixed to the cleaning cover 52, and at least the end portion of the cleaning nozzle 54 is located inside the cleaning cover 52. In this embodiment, the cleaning nozzle 54 includes a liquid nozzle 54A that supplies a liquid as the cleaning fluid, a jet nozzle 54B that supplies a jet of fluid as the cleaning fluid, and a chemical liquid nozzle 54C that supplies a chemical liquid as the cleaning fluid.

The liquid nozzle 54A, the jet nozzle 54B, and the chemical liquid nozzle 54C are connected to fluid valves 55A, 55B, and 55C, respectively. The liquid, the fluid for forming a jet, and the chemical liquid are respectively supplied to the liquid nozzle 54A, the jet nozzle 54B, and the chemical liquid nozzle 54C through the fluid valves 55A, 55B, and 55C. The fluid valves 55A, 55B, and 55C are actuator-driven on-off valves such as electric valves, solenoid valves, or air-operated valves. The fluid valves 55A, 55B, and 55C are electrically connected to the operation controller 40, and the operations of the fluid valves 55A, 55B, and 55C are controlled by the operation controller 40.

The configuration of the cleaning nozzle 54 is not limited to this embodiment, and it is sufficient that the cleaning nozzle 54 includes at least one of the liquid nozzle 54A, the jet nozzle 54B, and the chemical liquid nozzle 54C. For example, the cleaning nozzle 54 may include only the jet nozzle 54B, or may include only the liquid nozzle 54A and the jet nozzle 54B.

The actuator 56 is fixed to the housing 51 by a support member (not shown). The actuator 56 is connected to the cleaning cover 52 by a connecting member 57 and is configured to move the cleaning cover 52 up and down. More specifically, the actuator 56 is configured to move the cleaning cover 52 and the cleaning nozzle 54 (liquid nozzle 54A, jet nozzle 54B, and chemical liquid nozzle 54C) up and down together relative to the housing 51. The actuator 56 may be a combination of a ball screw and a servo motor. In one embodiment, the cleaning nozzle 54 may be fixed to a stationary member (not shown) instead of being fixed to the cleaning cover 52, and the actuator 56 may be configured to move only the cleaning cover 52 up and down.

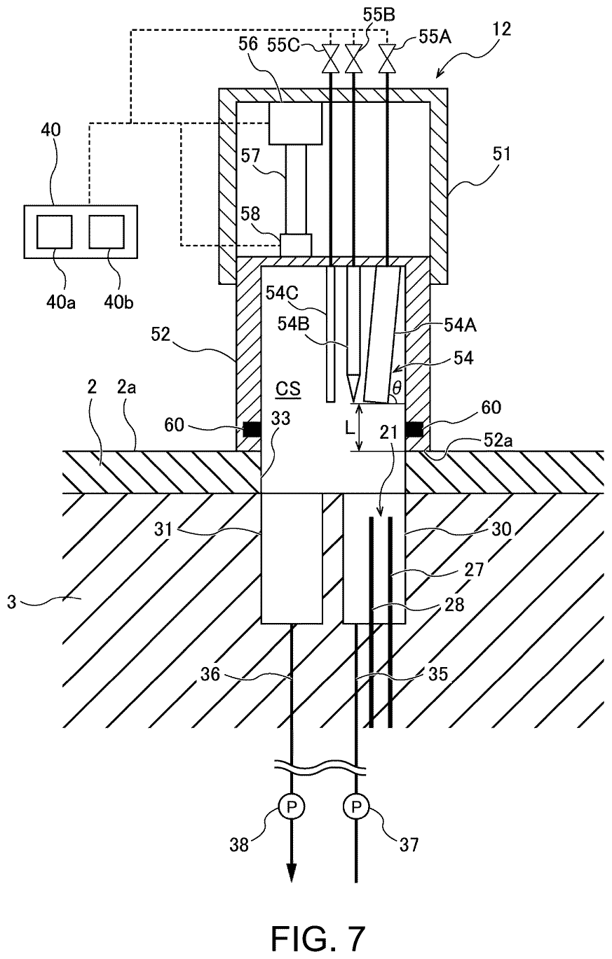

FIG. 7 is a schematic view showing a state where the actuator 56 lowers the cleaning cover 52. The actuator 56 is electrically connected to the operation controller 40, and the operation of the actuator 56 is controlled by the operation controller 40. As described above, after the cleaning portion 12 and the through hole (light passing portion) 33 of the polishing pad 2 are aligned with each other, the operation controller 40 gives a command to the actuator 56 to lower the cleaning cover 52 into contact with the polishing pad 2 while keeping the polishing table 3 stationary. More specifically, the operation controller 40 gives a command to the actuator 56 to lower the cleaning cover 52 until the lower surface 52a of the cleaning cover 52 comes into contact with the polishing surface 2a of the polishing pad 2.

The load measuring device 58 is attached to the upper part of the cleaning cover 52 and is configured to measure the load applied to the cleaning cover 52. The load measuring device 58 is connected to the actuator 56 via the connecting member 57 and is located between the actuator 56 and the cleaning cover 52. When the lower surface 52a of the cleaning cover 52 comes into contact with the polishing surface 2a of the polishing pad 2, a reaction force is applied to the cleaning cover 52 from the polishing surface 2a. This reaction force is measured by the load measuring device 58 as the load applied to the cleaning cover 52. The load measuring device 58 may be a load cell.

The load measuring device 58 is electrically connected to the operation controller 40, and the load applied to the cleaning cover 52, which is measured by the load measuring device 58, is sent to the operation controller 40. The operation controller 40 causes the actuator 56 to lower the cleaning cover 52 until the load measured by the load measuring device 58 reaches a load target value. Thereafter, the operation controller 40 controls the operation of the actuator 56 so that the load measured by the load measuring device 58 is maintained at the load target value. The load target value is a load predetermined so that the polishing surface 2a of the polishing pad 2 and the lower surface 52a of the cleaning cover 52 are in close contact with each other and the cleaning space CS is closed by the polishing pad 2.

The cleaning portion 12 forms the cleaning space CS that covers the through hole (light passing portion) 33 above the through hole (light passing portion) 33. When the cleaning cover 52 having therein the cleaning space CS that opens downward comes into contact with the polishing surface 2a of the polishing pad 2, the cleaning space CS is closed by the polishing pad 2. The cleaning cover 52 is disposed so as to surround the through hole (light passing portion) 33 of the polishing pad 2. The closed cleaning space CS faces the through hole (light passing portion) 33 of the polishing pad 2, the first hole 30 (including the optical sensor 21) of the polishing table 3, and the second hole 31. The cleaning nozzle 54 is configured to supply the cleaning fluid into the cleaning space CS. More specifically, the cleaning nozzle 54 supplies the cleaning fluid to the through hole (light passing portion) 33 through the cleaning space CS. In this embodiment, the liquid nozzle 54A supplies a liquid into the cleaning space CS, the jet nozzle 54B supplies a jet of fluid into the cleaning space CS, and the chemical liquid nozzle 54C supplies a chemical liquid into the cleaning space CS. The specific configuration of the cleaning nozzle 54 is not limited to this embodiment so long as the cleaning nozzle 54 is capable of supplying the cleaning fluid into the cleaning space CS.

A distance L from the tip of the cleaning nozzle 54 to the lower surface 52a of the cleaning cover 52 is determined based on the type of nozzle and the state of matter adhering to the through hole (light passing portion) 33. In one embodiment, the cleaning portion 12 further includes a nozzle position adjustment mechanism (not shown) connected to the cleaning nozzle 54, and the nozzle position adjustment mechanism may be configured to adjust the distance L from the tip of the cleaning nozzle 54 to the lower surface 52a of the cleaning cover 52. In one embodiment, the distance L from the cleaning nozzle 54 to the lower surface 52a of the cleaning cover 52 is 2 mm to 5 mm. In one embodiment, the distances from the tips of the liquid nozzle 54A, the jet nozzle 54B, and the chemical liquid nozzle 54C to the lower surface 52a of the cleaning cover 52 may be different. For example, the distance from the tip of the jet nozzle 54B to the lower surface 52a of the cleaning cover 52 and the distance from the tip of the chemical liquid nozzle 54C to the lower surface 52a of the cleaning cover 52 may be smaller than the distance from the tip of the liquid nozzle 54A to the lower surface 52a of the cleaning cover 52.

In one embodiment, the cleaning portion 12 further includes a nozzle angle adjustment mechanism (not shown) connected to the cleaning nozzle 54, and the nozzle angle adjustment mechanism may be configured to adjust an angle θ of the cleaning nozzle 54 with respect to the horizontal plane. In one embodiment, the angles of the liquid nozzle 54A, the jet nozzle 54B, and the chemical liquid nozzle 54C with respect to the horizontal plane may be different. For example, the angles of the liquid nozzle 54A, the jet nozzle 54B, and the chemical liquid nozzle 54C with respect to the horizontal plane may be adjusted so that the tips of the liquid nozzle 54A, the jet nozzle 54B, and the chemical liquid nozzle 54C are directed to the optical sensor 21.

The above-described fluid discharge line 36 communicates with the cleaning space CS through the second hole 31 and the through hole (light passing portion) 33, and is configured to discharge the cleaning fluid from the cleaning space CS and the through hole (light passing portion) 33 through the second hole 31. The cleaning fluid is supplied from the cleaning nozzle 54 (liquid nozzle 54A, jet nozzle 54B, and chemical liquid nozzle 54C) through the cleaning space CS to the through hole (light passing portion) 33, and removes the polishing liquid or polishing debris adhering to the through hole (light passing portion) 33. The cleaning fluid is discharged from the cleaning space CS and the through hole (light passing portion) 33 through the fluid discharge line 36 together with the polishing liquid or polishing debris.

In this manner, the cleaning portion 12 can supply the cleaning fluid to the through hole (light passing portion) 33 through the closed cleaning space CS, and remove the polishing liquid or polishing debris from the through hole (light passing portion) 33. Therefore, it is possible to prevent a decrease in intensity of the light reflected from the substrate W and passing through the light passing portion 33. As a result, the data processor 25 can determine the film thickness of the substrate W with high accuracy. In this embodiment, the cleaning portion 12 can also supply the cleaning fluid to the optical sensor 21 located inside the first hole 30, and remove the polishing liquid or polishing debris from the optical sensor 21.

During cleaning of the through hole (light passing portion) 33, the cleaning fluid is supplied into the closed cleaning space CS and discharged from the cleaning space CS through the fluid discharge line 36, so the cleaning fluid does not flow out to the outside of the cleaning space CS, that is, to the outside of the cleaning cover 52. Therefore, contamination of the polishing surface 2a caused by the cleaning fluid adhering to the outside of the through hole (light passing portions) 33 of the polishing pad 2 and changes in the properties of the polishing surface 2a can be prevented. In addition, since the cleaning fluid is selectively supplied to the through hole (light passing portion) 33 to be cleaned, the through hole (light passing portion) 33 can be cleaned efficiently, and the amount of cleaning fluid used can be reduced.

In this specification, the closing of the cleaning space CS does not necessarily mean that the cleaning space CS is completely closed (sealed), and there may be a small gap between the cleaning cover 52 and the polishing pad 2 as long as the above-mentioned effects can be achieved. That is, in this specification, the closing of the cleaning space CS also includes a state where there is a small gap between the cleaning cover 52 and the polishing pad 2 to an extent that allows the through hole (light passing portion) 33 to be efficiently cleaned without affecting contamination of the polishing surface 2a and changes in the properties of the polishing surface 2a, and the cleaning cover 52 is not completely in contact (close contact) with the polishing surface 2a of the polishing pad 2.

The liquid nozzle 54A, the jet nozzle 54B, and the chemical liquid nozzle 54C to be used are appropriately selected according to the state and type of the polishing liquid or polishing debris adhering to the through hole (light passing portion) 33, or a combination of these nozzles 54A, 54B, and 54C is used.

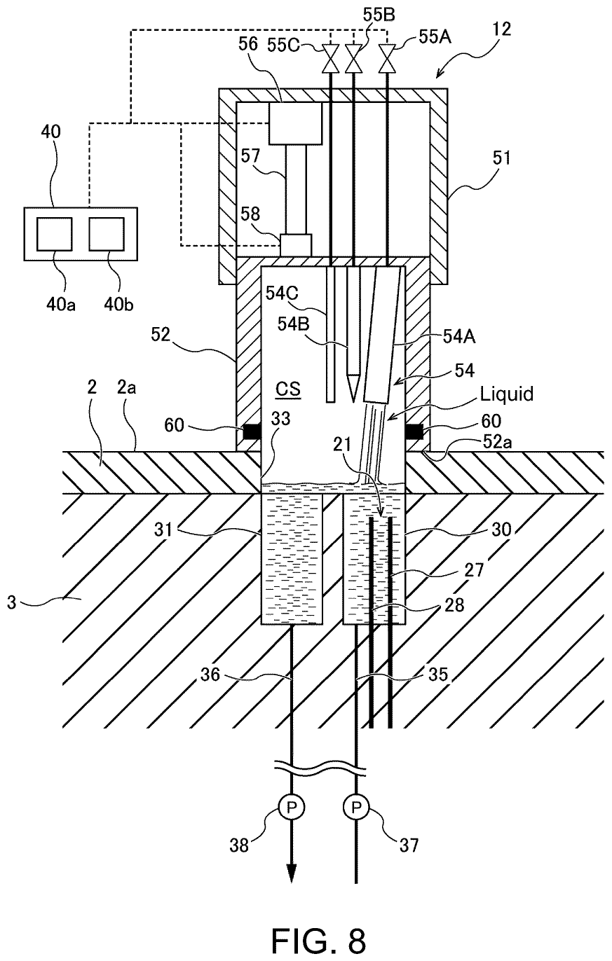

FIG. 8 is a schematic view showing how the liquid nozzle 54A supplies the liquid into the cleaning space CS. In this embodiment, the liquid nozzle 54A supplies a liquid (for example, pure water) as the cleaning fluid to the cleaning space CS, the through hole (light passing portion) 33, and the first hole 30 (including the optical sensor 21). While the liquid nozzle 54A supplies the liquid into the cleaning space CS and the through hole (light passing portion) 33, the discharge pump 38 discharges the liquid from the cleaning space CS and the through hole (light passing portion) 33 through the fluid discharge line 36. In one embodiment, the discharge pump 38 may discharge the liquid from the cleaning space CS and the through hole (light passing portion) 33 through the fluid discharge line 36 when a predetermined time has elapsed since the liquid nozzle 54A supplies the liquid into the cleaning space CS and the through hole (light passing portion) 33.

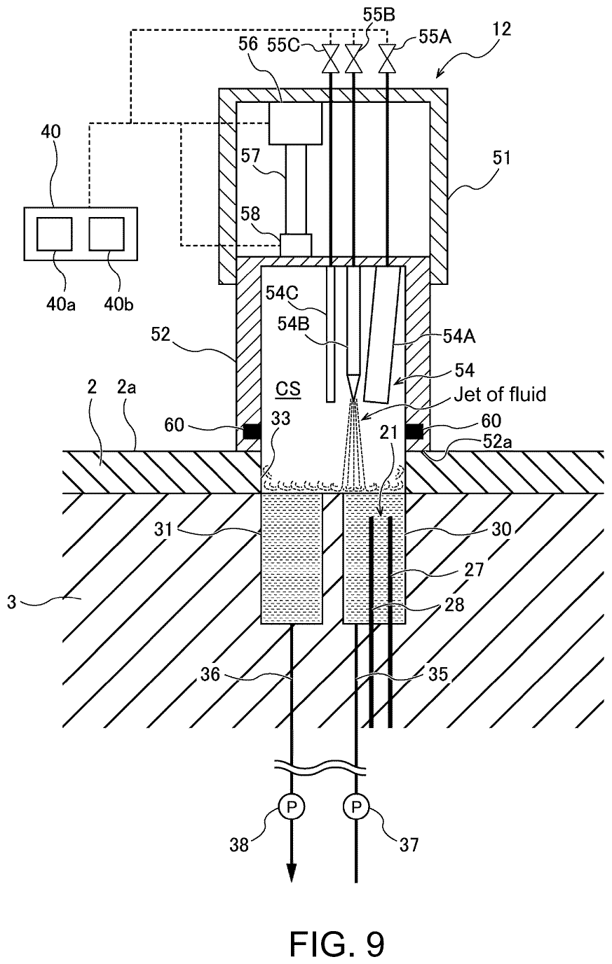

FIG. 9 is a schematic view showing how the jet nozzle 54B supplies a jet of fluid into the cleaning space CS. In this embodiment, the jet nozzle 54B supplies a jet of fluid as the cleaning fluid to the cleaning space CS, the through hole (light passing portion) 33, and the first hole 30 (including the optical sensor 21). The jet of fluid supplied from the jet nozzle 54B may be any one of a jet of liquid (for example, pure water), a jet of gas (for example, an inert gas such as nitrogen), and a jet of a mixture of liquid and gas.

While the jet nozzle 54B supplies a jet of fluid into the cleaning space CS and the through hole (light passing portion) 33, the discharge pump 38 discharges the fluid from the cleaning space CS and the through hole (light passing portion) 33 through the fluid discharge line 36. In one embodiment, the discharge pump 38 may discharge the fluid from the cleaning space CS and the through hole (light passing portion) 33 through the fluid discharge line 36 when a predetermined time has elapsed since the jet nozzle 54B supplies the jet of fluid into the cleaning space CS and the through hole (light passing portion) 33. In one embodiment, after the jet of fluid is supplied by the jet nozzle 54B, the liquid nozzle 54A may supply a liquid (for example, pure water) into the cleaning space CS and the through hole (light passing portion) 33 to rinse the cleaning space CS and the through hole (light passing portion) 33.

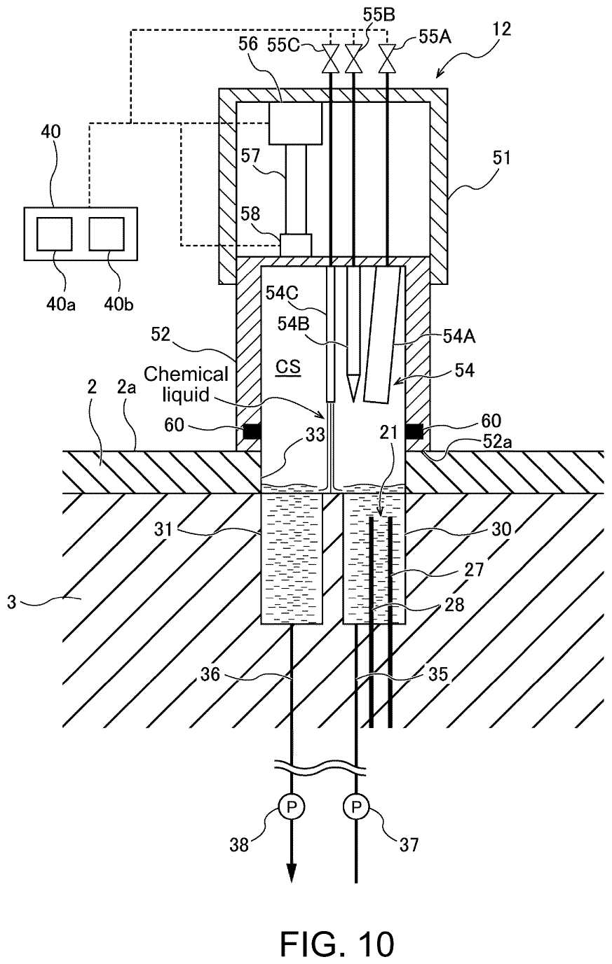

FIG. 10 is a schematic view showing how the chemical liquid nozzle 54C supplies the chemical liquid into the cleaning space CS. In this embodiment, the chemical liquid nozzle 54C supplies a chemical liquid as the cleaning fluid to the cleaning space CS, the through hole (light passing portion) 33, and the first hole 30 (including the optical sensor 21). Regarding the type of the chemical liquid used, a chemical liquid suitable for the type of the polishing liquid or polishing debris adhering to the through hole (light passing portion) 33 is used. For example, an acidic chemical liquid may be any solution of hydrofluoric acid, oxalic acid, citric acid, hydrochloric acid, and sulfuric acid, or a combination of these. An alkaline chemical liquid may be any solution of ammonia and TMAH (tetramethylammonium hydroxide), or a combination of these. Furthermore, a solution of a surfactant may be used as the chemical liquid.

While the chemical liquid nozzle 54C supplies the chemical liquid into the cleaning space CS and the through hole (light passing portion) 33, the discharge pump 38 discharges the chemical liquid from the cleaning space CS and the through hole (light passing portion) 33 through the fluid discharge line 36. In one embodiment, the discharge pump 38 may discharge the chemical liquid from the cleaning space CS and the through hole (light passing portion) 33 through the fluid discharge line 36 when a predetermined time has elapsed since the chemical liquid nozzle 54C supplies the chemical liquid into the cleaning space CS and the through hole (light passing portion) 33. In one embodiment, after the chemical liquid is supplied by the chemical liquid nozzle 54C, the liquid nozzle 54A may supply a liquid (for example, pure water) to the cleaning space CS and the through hole (light passing portion) 33 to rinse the cleaning space CS and the through hole (light passing portion) 33.

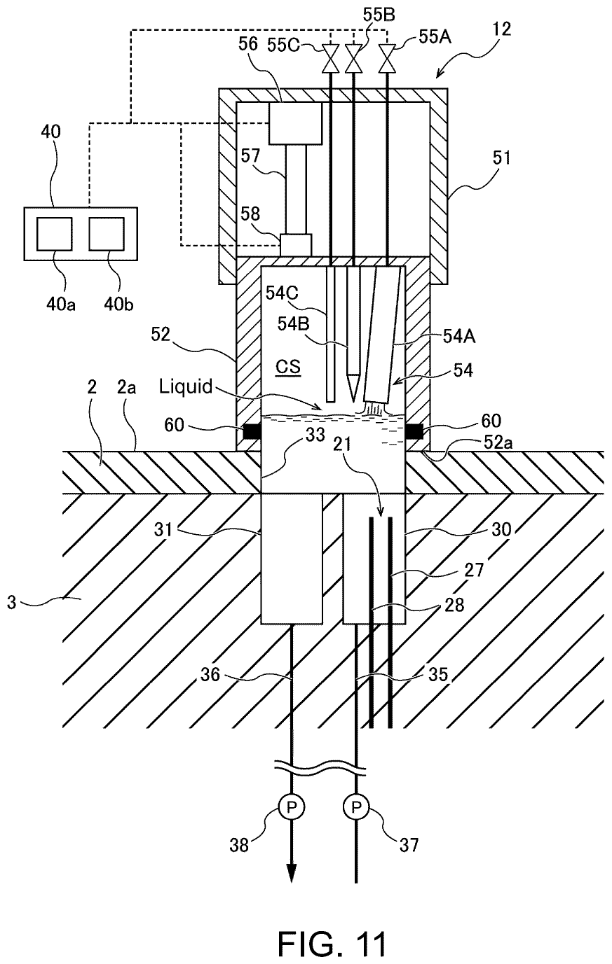

As shown in FIG. 11, the cleaning portion 12 further includes an ultrasonic vibrator 60 that generates ultrasonic waves. In this embodiment, the cleaning portion 12 includes two ultrasonic vibrators 60, which are disposed in the cleaning cover 52. More specifically, the ultrasonic vibrators 60 are disposed inside the cleaning cover 52. The number of ultrasonic vibrators 60 is not limited to this embodiment, and the cleaning portion 12 may include one ultrasonic vibrator 60 or three or more ultrasonic vibrators 60. The ultrasonic vibrator 60 is configured to generate ultrasonic waves. In a state where the cleaning fluid is supplied from the cleaning nozzle 54 into the cleaning space CS and the cleaning fluid is present in the cleaning space CS, the ultrasonic vibrator 60 propagates ultrasonic waves via the cleaning fluid. In this embodiment, the ultrasonic waves generated by the ultrasonic vibrator 60 are propagated to the through hole (light passing portion) 33 using the liquid supplied into the cleaning space CS by the liquid nozzle 54A as a medium. In one embodiment, the ultrasonic waves generated by the ultrasonic vibrator 60 may be propagated to the through hole (light passing portion) 33 through the cleaning cover 52 and the polishing pad 2 in a state where no cleaning fluid is present in the cleaning space CS.

The ultrasonic vibrator 60 is electrically connected to the operation controller 40, and the operation of the ultrasonic vibrator 60 is controlled by the operation controller 40. In a state of stopping the discharge pump 38, the operation controller 40 gives a command to the fluid valve 55A to supply the liquid from the liquid nozzle 54A into the cleaning space CS. In one embodiment, the operation controller 40 gives a command to the fluid valve 55A to supply the liquid from the liquid nozzle 54A into the cleaning space CS until the liquid level reaches a level higher than the position of the ultrasonic vibrator 60. Thereafter, the operation controller 40 gives a command to the ultrasonic vibrator 60 to cause the ultrasonic vibrator 60 to generate ultrasonic waves. The operation controller 40 operates the ultrasonic vibrator 60 until a predetermined cleaning time has elapsed, and then gives a command to the discharge pump 38 to discharge the liquid from the cleaning space CS and the through hole (light passing portion) 33 through the fluid discharge line 36. In one embodiment, the operation controller 40 may give a command to the ultrasonic vibrator 60 to cause the ultrasonic vibrator 60 to generate ultrasonic waves while supplying the liquid from the liquid nozzle 54A into the cleaning space CS and the through hole (light passing portion) 33, and discharging the liquid from the cleaning space CS and the through hole (light passing portion) 33 through the fluid discharge line 36.

The ultrasonic waves propagated to the through hole (light passing portion) 33 can remove the polishing liquid or polishing debris from the through hole (light passing portion) 33. In this embodiment, the ultrasonic vibrator 60 can also propagate ultrasonic waves to the optical sensor 21 located inside the first hole 30 and remove the polishing liquid or polishing debris from the optical sensor 21.

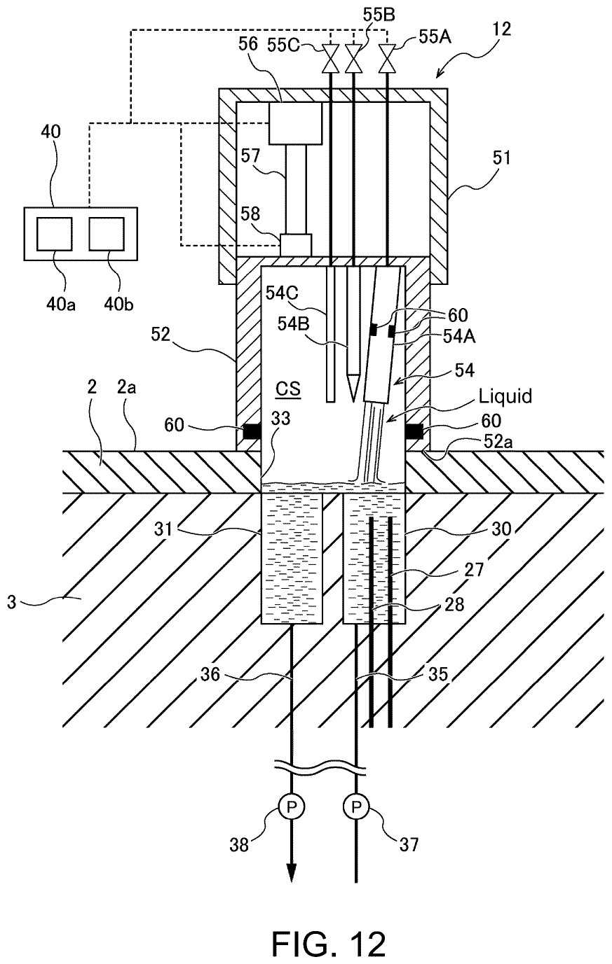

FIG. 12 is a schematic view showing another embodiment of the cleaning portion 12. The ultrasonic vibrator 60 of this embodiment is disposed in the cleaning nozzle 54. The ultrasonic vibrator 60 is configured to propagate ultrasonic waves via the cleaning fluid supplied from the cleaning nozzle 54 into the cleaning space CS. In this embodiment, the ultrasonic vibrator 60 is disposed in the liquid nozzle 54A. The ultrasonic waves generated by the ultrasonic vibrator 60 are propagated to the through hole (light passing portion) 33 using the liquid flowing out from the liquid nozzle 54A as a medium while the liquid is supplied from the liquid nozzle 54A into the cleaning space CS. In one embodiment, the ultrasonic vibrator 60 may be disposed in the jet nozzle 54B or the chemical liquid nozzle 54C.

The operation controller 40 gives a command to the ultrasonic vibrator 60 to cause the ultrasonic vibrator 60 to generate ultrasonic waves while giving a command to the fluid valve 55A to supply the liquid from the liquid nozzle 54A. In a state of stopping the discharge pump 38, the operation controller 40 gives a command to the ultrasonic vibrator 60 to propagate ultrasonic waves to the through hole (light passing portion) 33 via the liquid flowing out from the liquid nozzle 54A. The operation controller 40 operates the ultrasonic vibrator 60 until a predetermined cleaning time has elapsed, and then gives a command to the discharge pump 38 to discharge the liquid from the cleaning space CS and the through hole (light passing portion) 33 through the fluid discharge line 36. In one embodiment, the operation controller 40 may give a command to the ultrasonic vibrator 60 to cause the ultrasonic vibrator 60 to generate ultrasonic waves while supplying the liquid from the liquid nozzle 54A into the cleaning space CS and the through hole (light passing portion) 33, and discharging the liquid from the cleaning space CS and the through hole (light passing portion) 33 through the fluid discharge line 36.

The ultrasonic waves propagated to the through hole (light passing portion) 33 can remove the polishing liquid or polishing debris from the through hole (light passing portion) 33. In this embodiment, the ultrasonic vibrator 60 can also propagate ultrasonic waves to the optical sensor 21 located inside the first hole 30, and remove the polishing liquid or polishing debris from the optical sensor 21.

In one embodiment, the cleaning portion 12 may not include the ultrasonic vibrator 60 described with reference to FIG. 11 and FIG. 12.

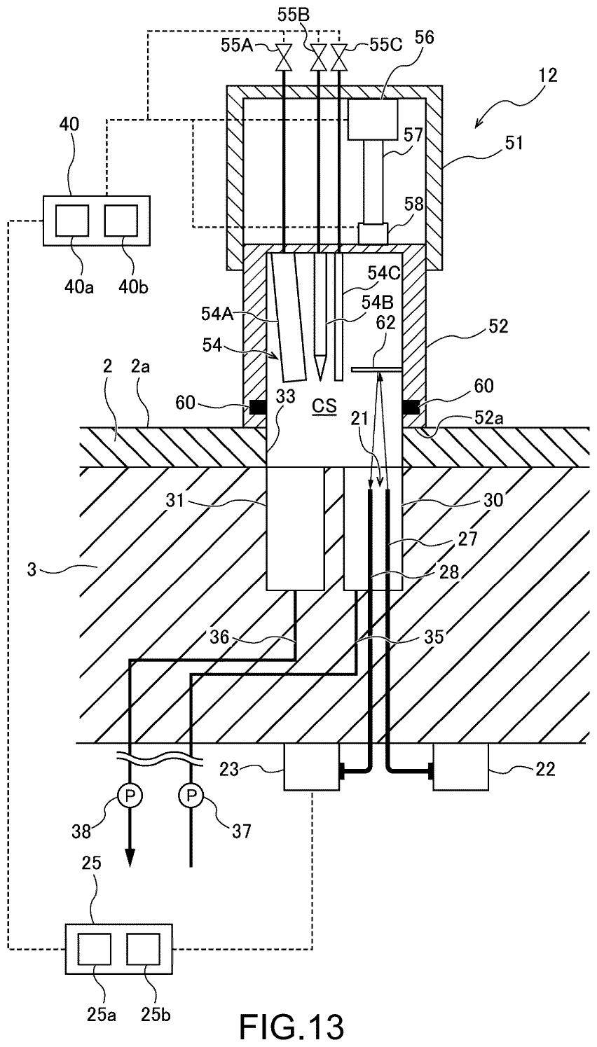

As shown in FIG. 13, in one embodiment, the cleaning portion 12 includes a mirror 62 for detecting the cleaning endpoint of the through hole (light passing portion) 33. The mirror 62 is disposed inside the cleaning cover 52. In other words, the mirror 62 is disposed in the cleaning space CS. The mirror 62 is disposed on the optical path of the light emitted from the optical sensor 21 through the through hole (light passing portion) 33, and the optical sensor 21 is configured to receive the reflected light from the mirror 62 through the through hole (light passing portion) 33.

During cleaning of the through hole (light passing portion) 33, the light emitted by the light source 22 passes through the light-projecting optical fiber cable 27, and is guided from the optical sensor 21 through the through hole (light passing portion) 33 to the mirror 62. The reflected light from the mirror 62 is received by the optical sensor 21 through the through hole (light passing portion) 33, and is sent to the spectroscope 23 through the light-receiving optical fiber cable 28. The spectroscope 23 resolves the reflected light according to the wavelength thereof and measures the intensity of the reflected light at each wavelength to generate reflected light intensity measurement data. The reflected light intensity measurement data is sent from the spectroscope 23 through the data processor 25 to the operation controller 40. In one embodiment, the operation controller 40 is directly connected to the spectroscope 23, and the reflected light intensity measurement data may be sent directly from the spectroscope 23 to the operation controller 40.

The optical sensor 21 may irradiate light to the mirror 62 in a state where the cleaning fluid is present in the cleaning space CS, or in a state where the cleaning fluid is discharged from the cleaning space CS and no cleaning fluid is present therein.

The operation controller 40 is configured to detect the cleaning endpoint of the through hole (light passing portion) 33, which is a time point when the intensity of the reflected light exceeds a threshold value, based on the intensity measurement data of the reflected light from the mirror 62. For example, the operation controller 40 may detect the cleaning endpoint of the through hole (light passing portion) 33, which is a time point when the intensity of the reflected light at a predetermined wavelength exceeds a threshold value, or detect the cleaning endpoint of the through hole (light passing portion) 33, which is a time point when the average intensity of the reflected light, obtained by averaging the intensity of the reflected light at each wavelength, exceeds a threshold value.

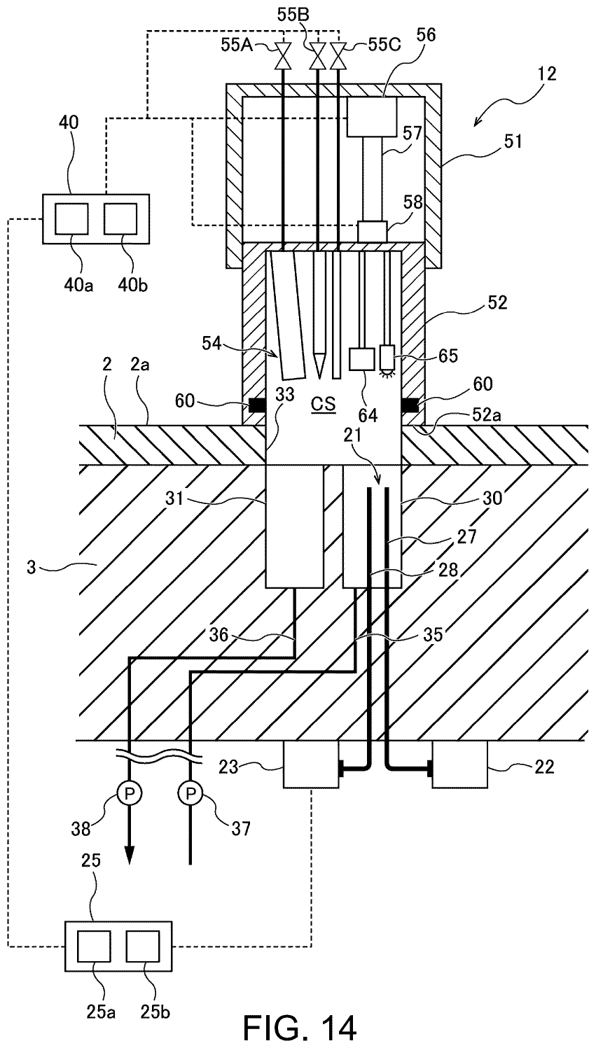

FIG. 14 is a schematic view showing yet another embodiment of the cleaning portion 12. The cleaning portion 12 of this embodiment includes, instead of the mirror 62, an imaging device 64 that generates an image of the through hole (light passing portion) 33, and an illuminator 65 for illuminating the through hole (light passing portion) 33. The imaging device 64 and the illuminator 65 are disposed inside the cleaning cover 52. In other words, the imaging device 64 and the illuminator 65 are disposed in the cleaning space CS. The imaging device 64 may be a camera including an image sensor such as a CCD sensor or a CMOS sensor, or a fiberscope. In one embodiment, the imaging device 64 has an illumination function for illuminating the through hole (light passing portion) 33, and the cleaning portion 12 may not include the illuminator 65.

The imaging device 64 is disposed above the through hole (light passing portion) 33 in the closed cleaning space CS, and is configured to generate an image of the through hole (light passing portion) 33. The imaging device 64 is electrically connected to the operation controller 40. The image of the through hole (light passing portion) 33 generated by the imaging device 64 is sent to the operation controller 40. The operation controller 40 is configured to detect the cleaning endpoint of the through hole (light passing portion) 33 based on the image sent from the imaging device 64. For example, the operation controller 40 detects the cleaning endpoint of the through hole (light passing portion) 33 based on a comparison between a reference image, which is an image of the through hole (light passing portion) 33 in a state where cleaning has been completed, and the acquired image.

The detection of the cleaning endpoint of the through hole (light passing portion) 33 described with reference to FIG. 13 and FIG. 14 may be performed at a predetermined time interval while the cleaning fluid is supplied to the through hole (light passing portion) 33 by the cleaning portion 12, or may be performed after the cleaning portion 12 has completed supplying the cleaning fluid to the through hole (light passing portion) 33 based on a predetermined cleaning recipe.

As described with reference to FIG. 13 and FIG. 14, the operation controller 40 gives a command to the fluid valves 55A, 55B, and 55C to stop the supply of the cleaning fluid from the cleaning nozzle 54 based on the detected cleaning endpoint. In one embodiment, the operation controller 40 may give a command to the fluid valves 55A, 55B, and 55C to stop the supply of the cleaning fluid from the cleaning nozzle 54 when a predetermined transition time has elapsed from the cleaning endpoint of the through hole (light passing portion) 33. As described with reference to FIG. 11 and FIG. 12, the operation controller 40 gives a command to the ultrasonic vibrator 60 to stop the generation of ultrasonic waves performed by the ultrasonic vibrator 60 when ultrasonic waves are generated by the ultrasonic vibrator 60. The operation controller 40 gives a command to the discharge pump 38 to discharge the cleaning fluid from the cleaning space CS through the fluid discharge line. After the cleaning fluid is discharged from the cleaning space CS, the operation controller 40 gives a command to the actuator 56 to raise the cleaning cover 52 and separate the cleaning cover 52 from the polishing pad 2. Furthermore, the operation controller 40 gives a command to the cleaning portion horizontal moving mechanism 18 to horizontally move the cleaning arm 16 and retract the cleaning portion 12 to the outside of the polishing pad 2.

In one embodiment, the operation controller 40 is configured to determine whether or not it is a cleaning time for the through hole (light passing portion) 33 based on the reflected light from the substrate W when measuring the film thickness of the substrate W during polishing of the substrate W. When the polishing liquid or polishing debris adheres to the through hole (light passing portion) 33, the intensity of the reflected light from the substrate W received by the optical sensor 21 decreases. Therefore, the operation controller 40 can determine whether or not it is the cleaning time for the through hole (light passing portion) 33 based on the intensity of the reflected light from the substrate W received by the optical sensor 21. More specifically, the operation controller 40 is configured to determine whether or not it is the cleaning time for the through hole (light passing portion) 33 based on the intensity measurement data of the reflected light from the substrate W generated by the spectroscope 23. For example, the operation controller 40 may determine that it is the cleaning time for the through hole (light passing portion) 33 when the intensity of the reflected light at a predetermined wavelength falls below a reference value. Alternatively, the operation controller 40 may determine that it is the cleaning time for the through hole (light passing portion) 33 when the average intensity of the reflected light, obtained by averaging the intensities of the reflected light within a specified wavelength range, falls below a reference value.

In one embodiment, the operation controller 40 may determine whether or not it is the cleaning time for the through hole (light passing portion) 33 based on the spectrum of the reflected light from the substrate W generated by the data processor 25. For example, the operation controller 40 determines whether or not it is the cleaning time for the through hole (light passing portion) 33 based on a comparison between a reference spectrum, which is the spectrum of the reflected light at the time of cleaning the through hole (light passing portion) 33, and the spectrum of the reflected light generated by the data processor 25.

The operation controller 40 may be configured to clean the through hole (light passing portion) 33 after polishing the substrate W in a case of determining that it is the cleaning time for the through hole (light passing portion) 33 during polishing of the substrate W. In one embodiment, the operation controller 40 may be configured to determine that it is the cleaning time for the through hole (light passing portion) 33, and then clean the through hole (light passing portion) 33 after polishing a predetermined number of substrates. According to this embodiment, the through hole (light passing portion) 33 can be automatically cleaned at an appropriate timing, so the efficiency of the cleaning work of the through hole (light passing portion) 33 can be improved.

The spectrum of the reflected light from the substrate W generated by the data processor 25 may change depending on the type of the polishing liquid or polishing debris adhering to the through hole (light passing portion) 33. In one embodiment, the operation controller 40 is configured to determine the type of the adhering matter based on the spectrum of the reflected light from the substrate W generated by the data processor 25. The operation controller 40 may be configured to select the cleaning nozzle 54 (liquid nozzle 54A, jet nozzle 54B, and chemical liquid nozzle 54C) to be used when supplying the cleaning fluid to the through hole (light passing portion) 33 based on the determined type of the adhering matter.

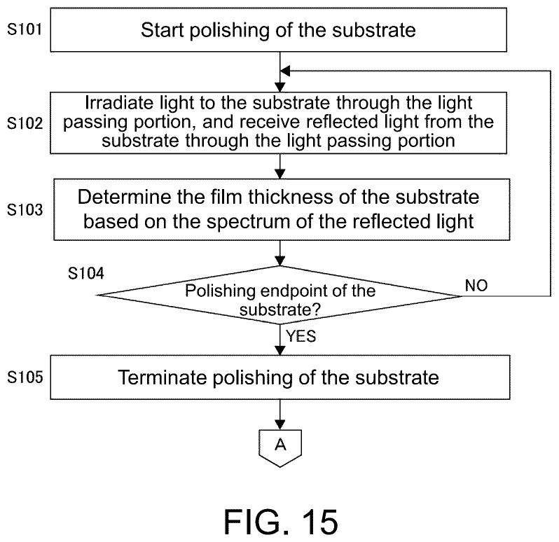

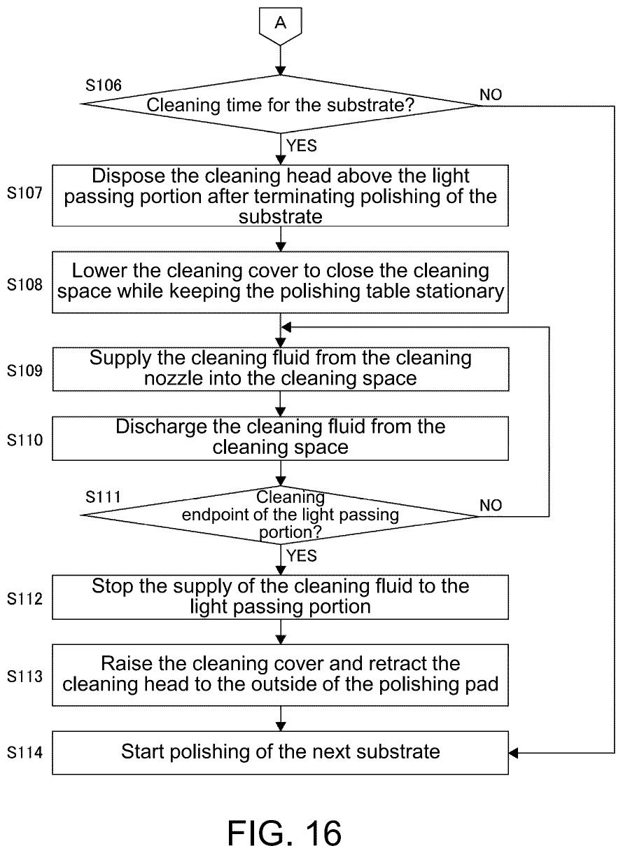

FIG. 15 and FIG. 16 are flowcharts showing one embodiment of a polishing method of the substrate W.

In step S101, the operation controller 40 gives commands to the polishing head 5, the table motor 6, the polishing liquid supply nozzle 8, and the polishing head rotating mechanism, and supplies a polishing liquid (slurry) onto the polishing pad 2 from the polishing liquid supply nozzle 8 while rotating the polishing head 5 and the polishing table 3. In this state, the substrate W is pressed against the polishing surface 2a of the polishing pad 2 by the polishing head 5 to start the polishing of the substrate W.

In step S102, the optical sensor 21 irradiates light to the substrate W through the through hole (light passing portion) 33 of the polishing pad 2, and receives the reflected light from the substrate W through the through hole (light passing portion) 33.

In step S103, the data processor 25 generates the spectrum of the reflected light from the substrate W from the reflected light intensity measurement data, and determines the film thickness of the substrate W from the spectrum of the reflected light.

In step S104, the operation controller 40 detects the polishing endpoint of the substrate W based on the film thickness of the substrate W. For example, the operation controller 40 is configured to detect the polishing endpoint of the substrate W, which is a time point when the film thickness of the substrate W reaches a target film thickness. When the operation controller 40 has not detected the polishing endpoint of the substrate W (“NO” in step S104), the operation controller 40 continues polishing the substrate W and repeats steps S102 to S104. When the operation controller 40 detects the polishing endpoint of the substrate W (“YES” in step S104), the operation controller 40 terminates polishing of the substrate W (step S105). Specifically, the operation controller 40 gives commands to the table motor 6 and the polishing head rotating mechanism to stop the rotation of the polishing table 3 and the polishing head 5 and terminate polishing of the substrate W based on the polishing endpoint of the substrate W.

Steps S106 to S113 described below are one embodiment of a cleaning method for the through hole (light passing portion) 33.

In step S106, the operation controller 40 determines whether or not it is the cleaning time for the through hole (light passing portion) 33 based on the reflected light from the substrate W received by the optical sensor 21 in step S102. In one embodiment, step S106 is performed in parallel with steps S102 to S104. In a case where step S102 is repeated, step S106 is also repeated. In a case of determining that it is the cleaning time for the through hole (light passing portion) 33 (“YES” in step S106), the operation controller 40 disposes the cleaning portion 12 above the through hole (light passing portion) 33 (step S107) after terminating polishing of the substrate W. Specifically, the operation controller 40 gives commands to the table motor 6 and the cleaning portion horizontal moving mechanism 18 to rotate the polishing table 3 and horizontally move the cleaning portion 12 so that the position of the through hole (light passing portion) 33 coincides with the position of the cleaning cover 52 of the cleaning portion 12. In a case of determining that it is not the cleaning time for the through hole (light passing portion) 33 (“NO” in step S106), the operation controller 40 starts polishing the next substrate after terminating polishing of the substrate W (step S114).

In step S108, the operation controller 40 gives a command to the actuator 56 to lower the cleaning cover 52 into contact with the polishing pad 2 while keeping the polishing table 3 stationary. Thereby, the cleaning space CS formed inside the cleaning cover 52 is closed.

In step S109, the operation controller 40 gives a command to at least one of the fluid valves 55A, 55B, and 55C to supply the cleaning fluid from the cleaning nozzle 54 into the cleaning space CS. The cleaning fluid supplied into the cleaning space CS can remove the polishing liquid or polishing debris through the through hole (light passing portion) 33. In one embodiment, as described with reference to FIG. 11 and FIG. 12, the operation controller 40 may generate ultrasonic waves with the ultrasonic vibrator 60 and propagate the ultrasonic waves via the cleaning fluid, thereby removing the polishing liquid or polishing debris from the through hole (light passing portion) 33.

In step S110, the operation controller 40 gives a command to the discharge pump 38 to discharge the cleaning fluid from the cleaning space CS through the fluid discharge line 36 while supplying the cleaning fluid from the cleaning nozzle 54 into the cleaning space CS or after supplying the cleaning fluid from the cleaning nozzle 54 into the cleaning space CS.

In step S111, the operation controller 40 detects the cleaning endpoint of the through hole (light passing portion) 33. As described with reference to FIG. 13, the operation controller 40 may detect the cleaning endpoint of the through hole (light passing portion) 33, which is a time point when the intensity of the reflected light exceeds a threshold value, based on the intensity measurement data of the reflected light from the mirror 62. Alternatively, as described with reference to FIG. 14, the operation controller 40 may detect the cleaning endpoint of the through hole (light passing portion) 33 based on an image generated by the imaging device 64.

When the operation controller 40 has not detected the cleaning endpoint of the through hole (light passing portion) 33 (“NO” in step S111), the operation controller 40 continues supplying the cleaning fluid to the through hole (light passing portion) 33 and repeats steps S109 to S111. When the operation controller 40 detects the cleaning endpoint of the through hole (light passing portion) 33 (“YES” in step S111), the operation controller 40 gives a command to at least one of the fluid valves 55A, 55B, and 55C to stop the supply of the cleaning fluid from the cleaning nozzle 54 based on the cleaning endpoint of the through hole (light passing portion) 33 (step S112). In one embodiment, the operation controller 40 may give a command to at least one of the fluid valves 55A, 55B, 55C to stop the supply of the cleaning fluid from the cleaning nozzle 54 when a predetermined transition time has elapsed from the cleaning endpoint of the through hole (light passing portion) 33. As described with reference to FIG. 11 and FIG. 12, when ultrasonic waves are generated by the ultrasonic vibrator 60, the operation controller 40 gives a command to the ultrasonic vibrator 60 to stop the generation of ultrasonic waves performed by the ultrasonic vibrator 60. The operation controller 40 gives a command to the discharge pump 38 to discharge the cleaning fluid from the cleaning space CS through the fluid discharge line.

In step S113, after the cleaning fluid is discharged from the cleaning space CS, the operation controller 40 gives a command to the actuator 56 to raise the cleaning cover 52 and separate the cleaning cover 52 from the polishing pad 2. Furthermore, the operation controller 40 gives a command to the cleaning portion horizontal moving mechanism 18 to horizontally move the cleaning arm 16 and retract the cleaning portion 12 to the outside of the polishing pad 2.

In step S114, the operation controller 40 starts polishing the next substrate. In this manner, the cleaning portion 12 supplies the cleaning fluid to the through hole (light passing portion) 33 through the closed cleaning space CS after or before polishing the substrate, thereby removing the polishing liquid or polishing debris from the through hole (light passing portion) 33.

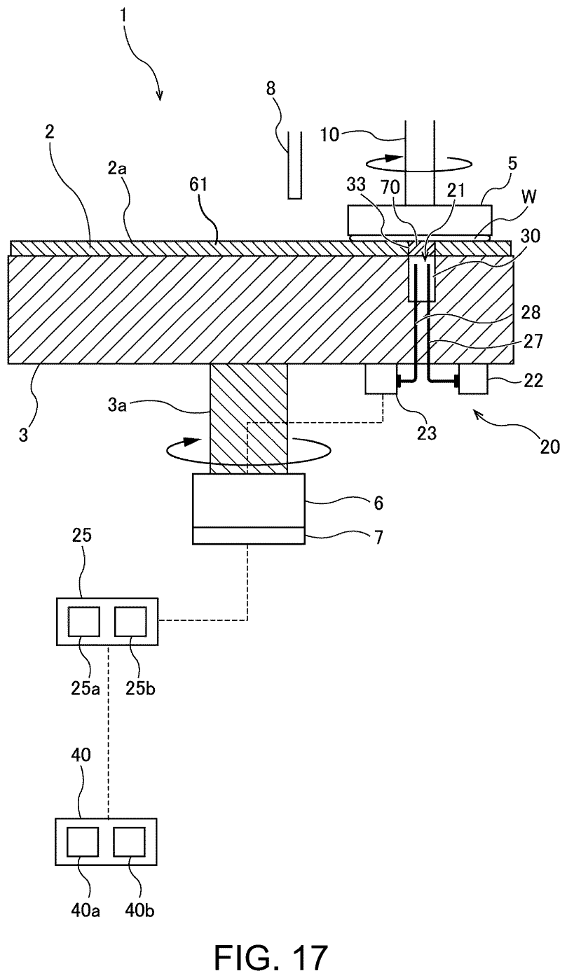

FIG. 17 is a cross-sectional view showing another embodiment of the polishing apparatus 1. Since the configuration and operation of this embodiment that are not specifically described are the same as those of the embodiment described with reference to FIG. 1 and FIG. 2, the repeated description will be omitted. In this embodiment, the light passing portion is a transparent window 70 made of a material that allows light to pass through. That is, the polishing pad 2 has the transparent window 70 as the light passing portion. The polishing apparatus 1 of this embodiment does not include the above-mentioned fluid supply line 35 and fluid discharge line 36, and the polishing table 3 does not have the above-mentioned second hole 31.

The transparent window 70 is fitted into the through hole 33 formed in the polishing pad 2. The transparent window 70 is located directly above the first hole 30 and the optical sensor 21. Therefore, the optical sensor 21 irradiates light to the substrate W through the transparent window 70 and receives reflected light from the substrate W through the transparent window 70. The material of the transparent window 70 is not particularly limited, but the transparent window 70 is made of transparent resin, for example.

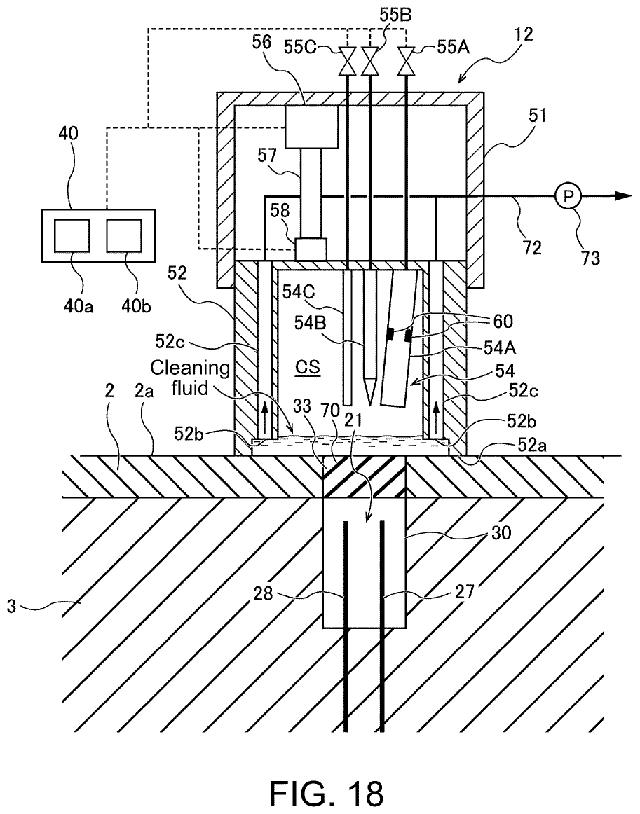

FIG. 18 is a schematic view showing one embodiment of the cleaning portion 12 of the polishing apparatus 1 shown in FIG. 17. Since the configuration and operation of this embodiment that are not specifically described are the same as those of the embodiment described with reference to FIG. 5 to FIG. 10 and FIG. 12, the repeated description will be omitted. In this embodiment, the polishing apparatus 1 includes a fluid discharge line 72 that communicates with an opening 52b formed on the inner surface of the cleaning cover 52, and a discharge pump 73 that is connected to the fluid discharge line 72. The cleaning cover 52 has two openings 52b formed on the inner surface thereof, and two flow paths 52c respectively extending upward from the two openings 52b. The fluid discharge line 72 is connected to the flow paths 52c, and communicates with the cleaning space CS through the flow paths 52c and the openings 52b.

In this embodiment, the opening 52b is located in a plane parallel to the lower surface 52a of the cleaning cover 52. The position of the opening 52b is not limited to this embodiment, and may be located within the side surface of the cleaning cover 52, for example. In this embodiment, the cleaning cover 52 has two openings 52b and two flow paths 52c, but the number of the openings 52b and the flow paths 52c is not limited to this embodiment. In one embodiment, the cleaning cover 52 may have one opening 52b and one flow path 52c, or may have three or more openings 52b and flow paths 52c.

The fluid discharge line 72 is configured to discharge the cleaning fluid from the cleaning space CS. The discharge pump 73 is configured to draw the cleaning fluid in the cleaning space CS through the fluid discharge line 72. The discharge pump 73 is electrically connected to the operation controller 40, and the operation of the discharge pump 73 is controlled by the operation controller 40.

In this embodiment, the cleaning cover 52 is disposed so as to surround the transparent window (light passing portion) 70 of the polishing pad 2. The cleaning space CS closed by the polishing pad 2 faces the transparent window (light passing portion) 70 of the polishing pad 2. In this embodiment, the cleaning nozzle 54 supplies the cleaning fluid to the upper surface of the transparent window (light passing portion) 70 through the cleaning space CS. The cleaning fluid supplied from the cleaning nozzle 54 (liquid nozzle 54A, jet nozzle 54B, and chemical liquid nozzle 54C) into the cleaning space CS removes the polishing liquid or polishing debris adhering to the transparent window (light passing portion) 70 and is discharged from the cleaning space CS through the fluid discharge line 72.

In this manner, the cleaning portion 12 supplies the cleaning fluid to the transparent window (light passing portion) 70 through the closed cleaning space CS. The cleaning fluid supplied into the cleaning space CS can remove the polishing liquid or polishing debris from the transparent window (light passing portion) 70. Therefore, it is possible to prevent a decrease in intensity of the light reflected from the substrate W and passing through the transparent window (light passing portion) 70. As a result, the data processor 25 can determine the film thickness of the substrate W with high accuracy.

The embodiment of the transparent window (light passing portion) 70 shown in FIG. 18 can be similarly applied to the embodiment for detecting the cleaning endpoint of the through hole (light passing portion) 33 described with reference to FIG. 13 and FIG. 14, and the embodiment for determining the cleaning time for the through hole (light passing portion) 33. In addition, the embodiment of the transparent window (light passing portion) 70 shown in FIG. 18 can also be applied to the embodiment of the ultrasonic vibrator 60 disposed in the cleaning cover 52 as described with reference to FIG. 11.

The above embodiments have been described for the purpose of enabling a person having ordinary knowledge in the art to which the disclosure pertains to practice the disclosure. Various modifications of the above embodiments would naturally be possible for a person skilled in the art, and the technical ideas of the disclosure may also be applied to other embodiments. Therefore, the disclosure is not limited to the described embodiments, but is to be interpreted in the broadest scope in accordance with the technical ideas defined by the claims.

What is claimed is:

1. A polishing apparatus, comprising:
a polishing table supporting a polishing pad that has a light passing portion;
a polishing head pressing a substrate against a polishing surface of the polishing pad;
an optical sensor disposed in the polishing table, irradiating light to the substrate through the light passing portion, and receiving reflected light from the substrate through the light passing portion; and
a cleaning portion forming a cleaning space that covers the light passing portion above the light passing portion and supplying a cleaning fluid to the light passing portion through the cleaning space.

2. The polishing apparatus according to claim 1, further comprising:
a fluid discharge line discharging the cleaning fluid from the cleaning space; and
an operation controller controlling an operation of the cleaning portion,
wherein the cleaning portion comprises:
a cleaning cover forming the cleaning space inside;
a cleaning nozzle supplying the cleaning fluid into the cleaning space; and
an actuator moving the cleaning cover up and down,
wherein the operation controller is configured to give a command to the actuator to lower the cleaning cover into contact with the polishing surface of the polishing pad, surround the light passing portion with the cleaning cover, and close the cleaning space.

3. The polishing apparatus according to claim 2, wherein the cleaning nozzle comprises at least one of a liquid nozzle that supplies a liquid as the cleaning fluid, a jet nozzle that supplies a jet of fluid as the cleaning fluid, and a chemical liquid nozzle that supplies a chemical liquid as the cleaning fluid.

4. The polishing apparatus according to claim 1, wherein the cleaning portion comprises an ultrasonic vibrator that generates ultrasonic waves and is configured to propagate the ultrasonic waves via the cleaning fluid.

5. The polishing apparatus according to claim 4, wherein the cleaning portion further comprises a cleaning cover that forms the cleaning space inside, and
the ultrasonic vibrator is disposed in the cleaning cover.

6. The polishing apparatus according to claim 4, wherein the cleaning portion further comprises a cleaning nozzle that supplies the cleaning fluid into the cleaning space, and
the ultrasonic vibrator is disposed in the cleaning nozzle.

7. The polishing apparatus according to claim 1, wherein the light passing portion is a through hole formed in the polishing pad.

8. The polishing apparatus according to claim 7, further comprising a fluid discharge line discharging the cleaning fluid from the cleaning space,
wherein the fluid discharge line communicates with the through hole and is configured to discharge the cleaning fluid from the cleaning space through the through hole.

9. The polishing apparatus according to claim 1, wherein the light passing portion is a transparent window made of a material that allows light to pass through.

10. The polishing apparatus according to claim 9, further comprising a fluid discharge line discharging the cleaning fluid from the cleaning space,
wherein the cleaning portion comprises a cleaning cover that forms the cleaning space inside, and
the fluid discharge line communicates with an opening formed on an inner surface of the cleaning cover and is configured to discharge the cleaning fluid from the cleaning space through the opening.

11. The polishing apparatus according to claim 2, wherein the cleaning portion further comprises a load measuring device that measures a load applied to the cleaning cover, and
the operation controller is configured to give a command to the actuator to lower the cleaning cover until the load measured by the load measuring device reaches a load target value.

12. The polishing apparatus according to claim 2, further comprising:
a table motor rotating the polishing table; and
a cleaning portion horizontal moving mechanism horizontally moving the cleaning portion,
wherein the operation controller is configured to control operations of the table motor and the cleaning portion horizontal moving mechanism, and
is configured to give commands to the table motor and the cleaning portion horizontal moving mechanism to rotate the polishing table and horizontally move the cleaning portion so that a position of the light passing portion coincides with a position of the cleaning cover.

13. The polishing apparatus according to claim 1, further comprising an operation controller that controls an operation of the cleaning portion,
wherein the cleaning portion comprises a mirror that is disposed on an optical path of the light irradiated from the optical sensor through the light passing portion,
the optical sensor is configured to receive reflected light from the mirror through the light passing portion, and
the operation controller is configured to detect a cleaning endpoint of the light passing portion, which is a time point when an intensity of the reflected light from the mirror exceeds a threshold value.

14. The polishing apparatus according to claim 1, further comprising an operation controller that controls an operation of the cleaning portion,
wherein the cleaning portion comprises an imaging device that generates an image of the light passing portion, and
the operation controller is configured to detect a cleaning endpoint of the light passing portion based on the image.

15. The polishing apparatus according to claim 1, further comprising an operation controller that controls an operation of the cleaning portion,
wherein the operation controller is configured to determine whether or not it is a cleaning time for the light passing portion based on the reflected light from the substrate.

16. A polishing method, comprising:
pressing a substrate against a polishing surface of a polishing pad supported by a polishing table, and polishing the substrate;
irradiating light to the substrate through a light passing portion provided in the polishing pad, and receiving reflected light from the substrate through the light passing portion with an optical sensor disposed in the polishing table during polishing of the substrate;
forming a cleaning space that covers the light passing portion above the light passing portion with a cleaning portion before or after polishing of the substrate; and
supplying a cleaning fluid to the light passing portion through the cleaning space with the cleaning portion.

17. The polishing method according to claim 16, wherein forming the cleaning space that covers the light passing portion above the light passing portion with the cleaning portion comprises disposing the cleaning portion above the light passing portion, and lowering a cleaning cover of the cleaning portion into contact with the polishing surface of the polishing pad to close the cleaning space formed inside the cleaning cover and surround the light passing portion with the cleaning cover,
supplying the cleaning fluid to the light passing portion through the cleaning space with the cleaning portion comprises supplying the cleaning fluid to the light passing portion from a cleaning nozzle of the cleaning portion through the cleaning space, and
the polishing method further comprises discharging the cleaning fluid from the cleaning space through a fluid discharge line.

18. The polishing method according to claim 16, further comprising generating ultrasonic waves with an ultrasonic vibrator and propagating the ultrasonic waves via the cleaning fluid.

19. The polishing method according to claim 16, wherein forming the cleaning space that covers the light passing portion above the light passing portion with the cleaning portion comprises measuring a load applied to a cleaning cover of the cleaning portion with a load measuring device, and lowering the cleaning cover until the measured load reaches a load target value to form the cleaning space that covers the light passing portion above the light passing portion.

20. The polishing method according to claim 17, wherein disposing the cleaning portion above the light passing portion comprises rotating the polishing table and horizontally moving the cleaning portion so that a position of the light passing portion coincides with a position of the cleaning cover, to dispose the cleaning portion above the light passing portion.

21. The polishing method according to claim 16, further comprising irradiating light to a mirror through the light passing portion, and receiving reflected light from the mirror with the optical sensor; and
detecting a cleaning endpoint of the light passing portion, which is a time point when an intensity of the reflected light exceeds a threshold value.

22. The polishing method according to claim 16, further comprising:
generating an image of a light projecting and receiving surface with an imaging device; and
detecting a cleaning endpoint of the light passing portion based on the image.

23. The polishing method according to claim 16, further comprising determining whether or not it is a cleaning time for the light passing portion based on the reflected light from the substrate.
